(19) United States
(12) Patent Application Publication
(10) Pub. No.: US 2010/0180646 A1
(43) Pub. Date: Jul. 22, 2010

(54) Dual lock box

(76) Inventor: James M. Mazingo, Houston, TX (US)

Correspondence Address: LITMAN LAW OFFICES, LTD., POST OFFICE BOX 41200, SOUTH STATION, ARLINGTON, VA, 22204, US

(21) Appl. No.: 12/591,552

(22) Filed: Nov. 23, 2009

Related U.S. Application Data
(60) Provisional application No. 61/202,028, filed on Jan. 21, 2009.

(51) Int. Cl. E05B 67/00; E05B 65/06

(52) U.S. Cl. 70/20; 70/91

(57) ABSTRACT

The dual lock box is a secure box or enclosure for receiving and storing documents or the like. The dual lock box is selectively locked by a pair of locks. The dual lock box may be opened by unlocking either one of the locks, without unlocking the other. The dual lock box includes a housing having an open front end. A pair of doors cover the open front end of the housing. Each of the doors is pivotally attached to opposing side edges of the box by hinges or the like. Each of the doors has a tang extending therefrom. A plate is having a pair of slots formed substantially centrally therethrough for receiving the tangs overlaps the doors. Each tang is adapted for engaging a respective one of the pair of locks.

### CROSS-REFERENCE TO RELATED APPLICATION

This application claims the benefit of U.S. Provisional Patent Application Ser. No. 61/202,028, filed Jan. 21, 2009.

### BACKGROUND OF THE INVENTION

1. Field of the Invention

The present invention relates to locking enclosures and more particularly to a dual lock box that is selectively locked by a pair of locks, such as padlocks or the like, but may be opened by unlocking either one or the other of the two locks, it being unnecessary to open both locks.

2. Description of the Related Art

Lock boxes are often used in commercial or residential structures for containing building plans, access keys, or the like. Such materials are often needed by the management of the building in the course of day-to-day operations. In the event of an emergency, first responders, such as the fire department, may also require access to these materials. Typical lock boxes, however, only include a single lock, requiring a key or combination, which is often known only to the building management. Thus, if the building management is not available, the fire department does not have access to the necessary plans or keys housed within the lock box.

In some localities, such lock boxes may have a single padlock, but only the fire department may have the key. In this case, the building management cannot gain access to the box without calling the fire department to have their personnel open the padlock. It would be desirable to provide a lock box that may be accessed by either the building management or the fire department without requiring the two parties to share the same keys or combinations. Thus, a dual lock box solving the aforementioned problems is desired.

### SUMMARY OF THE INVENTION

The dual lock box is a secure box or enclosure for receiving and storing documents, access keys, or the like. The dual lock box is selectively locked by a pair of locks, such as padlocks or the like. The box is configured so that the contents may be accessed by removing either one of the locks. The dual lock box may be used to house building floor plans, access keys or the like, and permits the box to be opened by the fire department without waiting for building management, or by building management without waiting for the fire department.

The dual lock box includes a housing having opposed upper and lower walls, a pair of opposed sidewalls, a rear wall and an open front end. The housing may be formed from metal, such as steel, or from any other suitably strong and secure material. A pair of doors cover the open front end of the housing, with each of the doors being pivotally secured to a respective one of the pair of sidewalls by hinges or the like. Each of the doors has a ring or tang extending from its outer face.

A central plate is provided, the plate having a pair of slots formed substantially centrally therethrough. The plate may have an upper portion, formed on an upper edge thereof, projecting rearwardly and substantially orthogonally to the main body of the plate.

When the dual lock box is in a closed and locked configuration, the plate is mounted over the outer faces of the doors so that each of the tangs extends through a respective one of the slots formed in the plate. Each of the locks engages a respective one of the tangs to releasably lock the plate to the pair of doors, with only one of the locks needing to be removed to open the dual lock box.

These and other features of the present invention will become readily apparent upon further review of the following specification and drawings.

### BRIEF DESCRIPTION OF THE DRAWINGS

FIG. 1 is a perspective view of a dual lock box according to the present invention, shown in a locked and closed configuration.

FIG. 2 is a partially exploded perspective view of the dual lock box of FIG. 1.

FIG. 3 is a perspective view of the dual lock box of FIG. 1, shown with the lock box being accessed by opening only the right-hand padlock.

FIG. 4 is a perspective view of the dual lock box of FIG. 1, shown with the lock box being accessed by opening only the left-hand padlock.

Similar reference characters denote corresponding features consistently throughout the attached drawings.

### DETAILED DESCRIPTION OF THE PREFERRED EMBODIMENTS

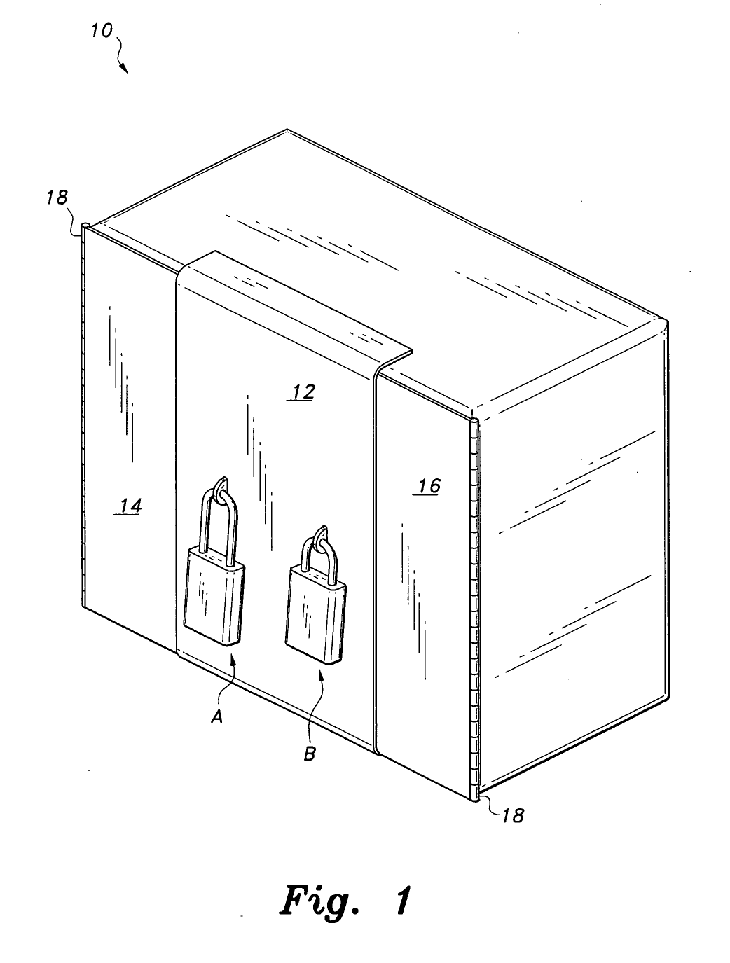

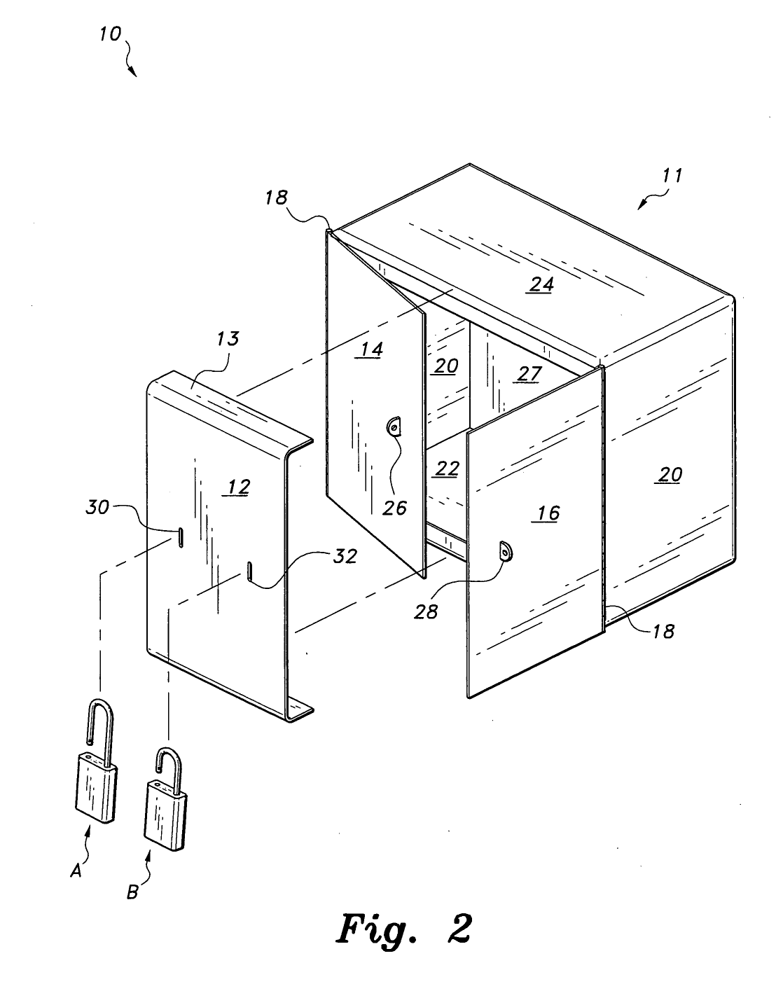

Referring to FIGS. 1 and 2, the dual lock box 10 is a secure box or enclosure for receiving and storing documents or the like. The dual lock box 10 is selectively locked by a pair of locks A and B, such as padlocks or the like. The dual lock box may be accessed by opening either one of the locks A, B, without the necessity of opening both of the locks A, B. The locks A, B may be key locks, combination locks, or other suitable lock.

The dual lock box 10 may be used to house building floor plans, access keys or the like, with the box 10 able to be opened by the fire department, for example, using the key to only one of the pair of locks A, B, or by building management, for example, using the key to the other one of the pair of locks A, B.

As best shown in FIG. 2, the dual lock box 10 preferably includes a housing 11 having opposed lower and upper walls 22, 24, a pair of opposed sidewalls 20, a rear wall 27 and an open front end. The housing 11 may be formed from metal, such as steel, or from any other suitably strong and secure material. It should be understood that housing 11 may have any suitable shape and dimensions, depending upon the materials to be stored therein, and that rectangular housing 11 is shown in the drawings for exemplary purposes only.

A pair of doors 14, 16 cover the open front end of the housing 11, with each of the doors being pivotally attached to a respective one of the pair of sidewalls 20 by hinges 18 or the like. It should be understood that doors 14, 16 may be pivotally secured to sidewalls 20 by any suitable type of pivotal attachment. Doors 14, 16 are preferably formed from a strong and secure material similar to that of housing 11. As shown, each of the doors 14, 16 has a respective ring or tang 26, 28 extending from the outer face thereof.

A central plate 12 is further provided. The plate 12 has a pair of slots 30, 32 formed substantially centrally therethrough, which are spaced apart laterally. Slots 30, 32 are dimensioned and configured to receive tangs 26, 28, respectively, therethrough. The plate 12 may further have an upper and lower flange or portion 13, formed on the upper and lower edges thereof, projecting rearwardly and substantially orthogonally to the main body of the plate 12. As best shown in FIG. 1, when the dual lock box 10 is in the closed configuration, the flanges 13 cover at least a portion of the junction between the doors 14, 16 and the upper wall 24 and lower wall 22, preventing insertion of a prying tool or the like therein.

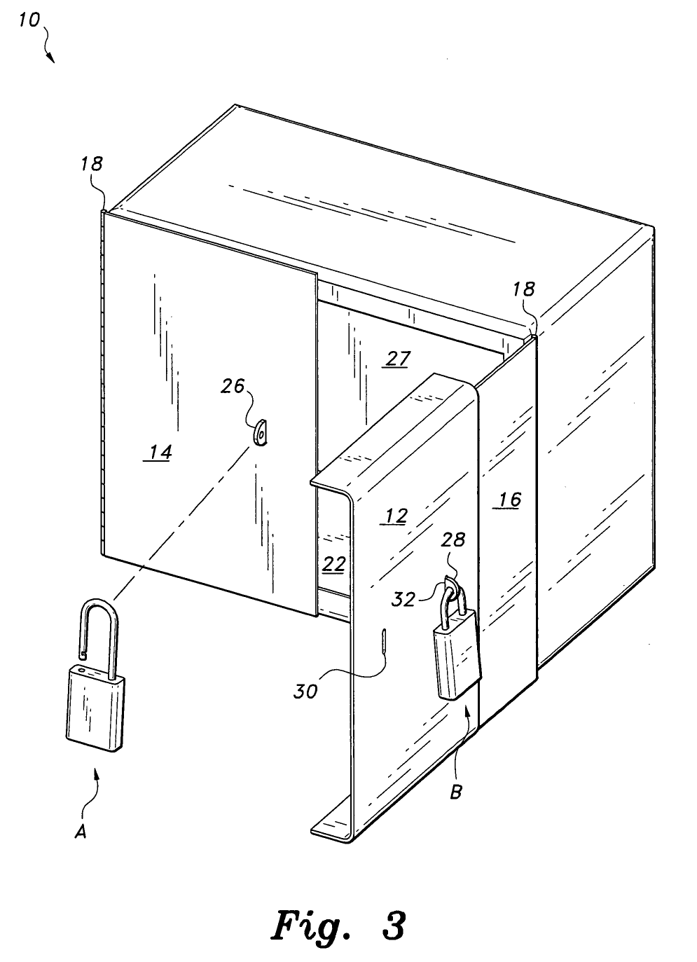

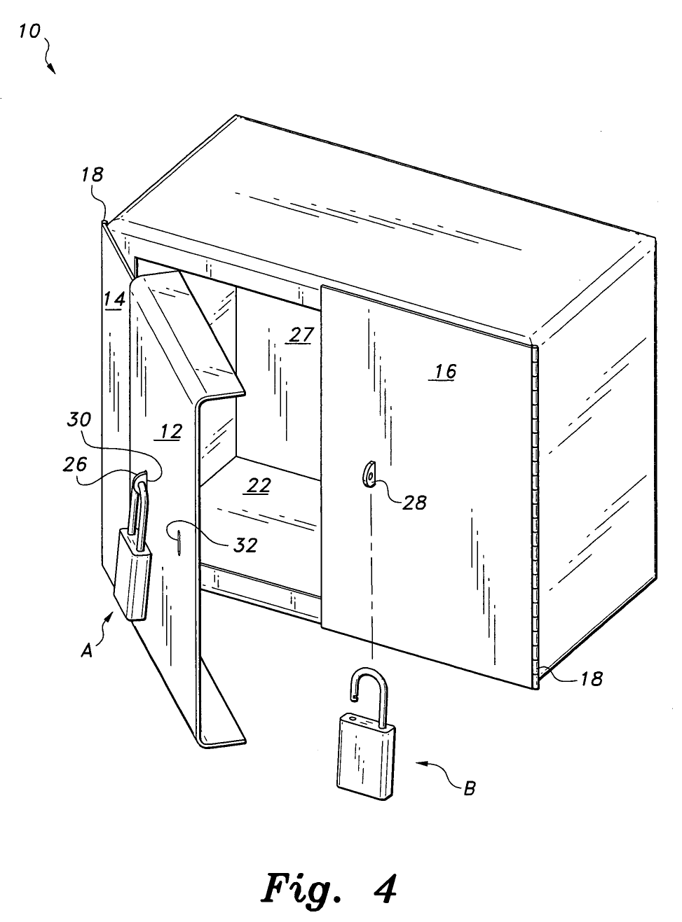

When the dual lock box 10 is in the closed and locked configuration (as in FIG. 1), the plate 12 is mounted on the outer faces of the pair of doors 14, 16. The tangs 26, 28 project through the slots 30, 32 formed through the plate 12. Each of the locks A, B engages a respective one of the tangs 26, 28 to releasably lock the plate 12 to the pair of doors 14, 16, with only one of locks A, B needing to be removed to open the dual lock box 10. As shown in FIG. 3, when lock A is removed, lock B holds plate 12 to door 16, with both doors able to be opened. Similarly, in FIG. 4, lock B is removed, holding plate 12 to door 14, but still allowing the dual lock box 10 to be opened. Only one of locks A, B needs to be removed in order to access the interior of housing 11, thus allowing access by only one of two parties, such as the fire department or building management.

It is to be understood that the present invention is not limited to the embodiments described above, but encompasses any and all embodiments within the scope of the following claims.

I claim:

1. A dual lock box, comprising:
a housing having opposed upper and lower walls, a pair of opposed sidewalls, a rear wall and an open front end, the housing defining a box;
a pair of doors covering the open front end of the housing, each of the doors being pivotally attached to a respective one of the pair of sidewalls, each of the doors having a tang extending therefrom;
a central plate having a pair of slots formed therethrough, the tangs extending through the slots when the doors are closed and the central plate is positioned to overlap the doors; and
a pair of padlocks removably extendable through the tangs;
wherein, when either one of the padlocks is unlocked and removed from the corresponding tang, the plate remains attached to the opposing door and pivots therewith to provide access to contents of the box.

2. The dual lock box as recited in claim 1, wherein said housing is substantially rectangular.

3. The dual lock box as recited in claim 2, wherein said central plate comprises:
a planar portion having opposed upper and lower ends; and
upper and lower flanges respectively joined to the upper and lower ends of the planar portion, each of the upper and lower flanges extending substantially orthogonal to the planar portion so that when the planar portion is mounted against the pair of doors, the upper and lower flanges at least partially cover the upper and lower walls of the housing.

4. The dual lock box as recited in claim 3, wherein the planar portion of said central plate is substantially rectangular.

5. The dual lock box as recited in claim 1, wherein each of said doors is substantially rectangular.

6. The dual lock box as recited in claim 5, further comprising a pair of hinges, each of the hinges being attached to a respective one of the pair of sidewalls for pivotal mounting of the pair of doors thereto.

7. A dual lock box, comprising:
a housing defining a box having an open front end;
a pair of doors covering the open front end of the housing, each of the doors being pivotally attached to opposing side edges of the housing, each of the doors having a tang extending therefrom;
a central plate having a pair of slots formed therein, the tangs extending through the slots when the doors are closed and the plate is positioned centrally to overlap the doors; and
a pair of locks extendable through the tangs;
wherein, when either one of the padlocks is unlocked and removed from the corresponding tang, the plate remains attached to the opposing door and pivots therewith to provide access to contents of the box.

8. The dual lock box as recited in claim 7, wherein said housing includes opposed upper and lower walls, a pair of opposed sidewalls and a rear wall.

9. The dual lock box as recited in claim 8, wherein said housing is substantially rectangular.

10. The dual lock box as recited in claim 8, wherein said central plate comprises:
a planar portion having opposed upper and lower ends; and
upper and lower flanges respectively joined to the upper and lower ends of the planar portion, each of the upper and lower flanges extending substantially orthogonal to the planar portion so that when the planar portion is mounted against the pair of doors, the upper and lower flanges at least partially cover the upper and lower walls of the housing.

11. The dual lock box as recited in claim 10, wherein the planar portion of said central plate is substantially rectangular.

12. The dual lock box as recited in claim 8, wherein each of said doors is substantially rectangular.

13. The dual lock box as recited in claim 8, further comprising a pair of hinges, each of the hinges being attached to a respective one of the pair of sidewalls for pivotal mounting of the pair of doors thereto.

14. A dual lock box, comprising:
a housing defining a box having an open front end;
a pair of doors covering the open front end of said housing, each of the doors being pivotally attached to opposing side edges of the housing, each of the doors having a tang extending therefrom; and
a central plate having a pair of slots formed therein, the tangs extending through the slots when the doors are closed and the plate is positioned centrally overlapping the doors, each of the tangs having an opening defined therein adapted for receiving a respective padlock, the central plate including a planar portion having opposed upper and lower ends, the central plate having upper and lower flanges respectively joined to the upper and lower ends of the planar portion, each of the upper and lower flanges extending substantially orthogonal to the planar portion so that when the planar portion is mounted against the pair of doors, the upper and lower flanges at least partially cover upper and lower walls of the housing;
wherein, when either one of the padlocks is unlocked and removed from the corresponding tang, the plate remains attached to the opposing door and pivots therewith to provide access to contents of the box.

15. The dual lock box as recited in claim 14, wherein said housing includes a pair of opposed sidewalls and a rear wall.

16. The dual lock box as recited in claim 14, wherein said housing is substantially rectangular.

17. The dual lock box as recited in claim 14, wherein the planar portion of said central plate is substantially rectangular.

18. The dual lock box as recited in claim 14, wherein each of said doors is substantially rectangular.

19. The dual lock box as recited in claim 14, further comprising a pair of hinges, each of the hinges being attached to said housing and to a corresponding one of said doors, the hinges pivotally attaching said doors to said housing.
